(19) United States
(12) Patent Application Publication
(10) Pub. No.: US 2013/0280523 A1
(43) Pub. Date: Oct. 24, 2013

(54) COATING COMPOSITION HAVING A TITANIUM-DIOXIDE-PRODUCING AGENT, NANOSCALE TITANIUM-DIOXIDE-BASED COATING, AND PRODUCTION, FURTHER PROCESSING AND USE THEREOF

(71) Applicants: Martin Schwarz, Dortmund (DE); Frank-Hendrik Wurm, Dortmund (DE); Beate Heisterkamp, Witten (DE); Ute Bergmann, Dresden (DE); Silvia Muehle, Dresden (DE); Hartmut Worch, Dresden (DE)

(72) Inventors: Martin Schwarz, Dortmund (DE); Frank-Hendrik Wurm, Dortmund (DE); Beate Heisterkamp, Witten (DE); Ute Bergmann, Dresden (DE); Silvia Muehle, Dresden (DE); Hartmut Worch, Dresden (DE)

(21) Appl. No.: 13/811,787

(22) PCT Filed: Jul. 27, 2011
(86) PCT No.: PCT/EP2011/003748

§ 371 Date: Apr. 30, 2013

(30) Foreign Application Priority Data
Jul. 29, 2010 (DE) 102010032619.4

(51) Int. Cl. C09D 7/12

(52) U.S. Cl. CPC C09D 7/1233
USPC 428/336; 106/217.7; 106/124.4; 106/14.41

(57) ABSTRACT

The invention relates to a coating composition containing between 51 wt % and 99.9 wt % of a TiO₂-producing agent, wherein the coating composition contains between 0.1 wt % and 49 wt %, relative to the total composition, of at least one further component which is selected from collagen, chitosans, phenols and/or substituted quaternary ammonium salts of alkylated phosphoric acid. The invention further relates to a nanoscale coating based on titanium dioxide, and to the production, further processing and use thereof.

The present invention relates to a coating composition on the basis of a titanium-dioxide-producing agent as well as of another component, to a nanoscale coating on the basis of polymerized titanium dioxide as well as of another component, to the production of this coating, to the further processing of the coating as well as to a number of applications, as explained in greater detail below.

### STATE OF THE ART

International patent application WO 2008/023025 A1=European patent application EP 2057206 A1 relates to a hybrid material consisting of a silicated collagen matrix which is obtained by mixing a homogeneous collagen suspension and a silicon precursor under agitation. This material can be employed as a structural material or as a coating.

### Invention

Coating Composition

A first objective of the invention is to put forward a novel coating composition which, in comparison to the prior-art silicated collagen matrix known from international patent application WO 2008/023025 A1, exhibits improved mechanical and application properties upon contact with fluids.

This objective is achieved by the combination of the titanium-dioxide-producing agent with specific amounts of other components, namely, connective tissue protein, chitosans, phenols and/or substituted quaternary ammonium salts of alkylated phosphoric acid.

Thus, the invention relates to a coating composition containing 51% to 99.9% by weight, preferably 70% to 99% by weight, especially 80% to 98% by weight, of a TiO₂-producing agent, whereby the coating composition contains 0.1% to 49% by weight, preferably 1% to 30% by weight, especially 2% to 20% by weight, relative to the total composition, of at least one additional component selected from among connective tissue protein, chitosans, phenols and/or substituted quaternary ammonium salts of alkylated phosphoric acid.

According to a preferred embodiment, up to 40 parts by weight, preferably 30 parts by weight, especially 20 parts by weight of the 100 parts by weight of the TiO₂-producing agent are replaced by a silicon-dioxide-producing agent.

According to another preferred embodiment, this additional component is a connective tissue protein, especially collagen, elastin, proteoglycan, fibronectin or laminin, obtained from vertebrates, preferably domesticated animals, especially pigs and/or cows and/or from the phylum Porifera, preferably of the class Demospongiae, particularly of the subclass Tetractinomorpha, order Chondrosida.

The collagen fiber networks obtained from vertebrates, especially from domesticated animals such as, for instance, cattle, calves, sheep, goats, pigs or collagen sponges are known, for example, from German preliminary published application no. 18 11 290, German preliminary published application no. 26 25 289, German patent specification no. 27 34 503 and especially from German preliminary published application no. 32 03 957.

This marine component also refers to the zoological designation of the marine animal group commonly referred to as sponges. These marine animals have a structure that is without symmetry but that has polarly organized shapes such as chunks, crusts, funnels or bowls, or else mushrooms or antlers and that is created by a skeleton which is made up of collagen (spongin) fibers into which spicules of calcite or silicic acid have been incorporated. The sponges usually have three layers of which the largest middle layer, the mesohyl, consists of a gelatinous matrix with collagen fibers. In this context, we hereby make reference to the Lexikon der Biologie [Encyclopedia of biology], Volume 7, Freiburg 1986, under the entry “Schwämme” [Sponges], ibid. Volume 8, under the entries “Spongia”, “Spongin”.

The phylum Porifera is divided into the classes Calcarea, that is to say, sponges with calcite incorporations, Hexactinellida, in other words, those having special silicic acid incorporations, and also Demospongiae, which include sponges having a fibrous or silicic acid skeleton. The group of the particularly well-suited class Demospongiae includes especially the horn siliceous sponges (Cornacu-spongia), the freshwater sponges and the bath sponges (Spongia officinalis) with the subspecies Turkey cup (Spongia officinalis mollissima), cimmoca sponge (Spongia officinalis cimmoca), elephant ear (Spongia officinalis lamella) as well as the horse sponge (Hippospongia communis) with its large openings. Sponges, which are harvested from the water, are freed of mineral components in a familiar manner, for instance, through acid digestion, so that the additional component collagen can be isolated.

Special preference is given to obtaining the collagen from Chondrosia reniformis.

According to another preferred embodiment of the present invention, the TiO₂-producing agent is selected from among:
0% to 100% by weight, preferably 1% to 99% by weight, of tetraethoxy orthotitanate,
0% to 100% by weight, preferably 1% to 99% by weight, of tetramethoxy orthotitanate,
0% to 100% by weight, preferably 1% to 99% by weight, of tetra-n-propoxy orthotitanate,
0% to 100% by weight, preferably 1% to 99% by weight, of tetra-i-propoxy orthotitanate, and
0% to 100% by weight, preferably 1% to 99% by weight, of tetra-t-butoxy orthotitanate,
0% to 100% by weight, preferably 1% to 99% by weight, of tetra-n-hexadecan-1-ol-oxyorthotitanate, and
0% to 100% by weight, preferably 1% to 99% by weight, of tetra-n-dodedecan-1-ol-oxyorthotitanate.

According to another preferred embodiment of the present invention, the SiO₂-producing agent is selected from among:
0% to 100% by weight, preferably 1% to 99% by weight, of tetraethoxy silane,
0% to 100% by weight, preferably 1% to 99% by weight, of trimethoxymethyl silane, and
0% to 100% by weight, preferably 1% to 99% by weight, of dimethoxydimethyl silane.

Another preferred embodiment of the present invention relates to the additional component that is selected from among cationic, anionic or non-ionic deacetylated chitosans and chitosan derivatives and/or phenols from the group of halogenated dihydroxydiphenyl methanes, dihydroxydiphenyl sulfides and dihydroxydiphenyl ethers and/or substituted quaternary ammonium salts of alkylated phosphoric acid.

Another preferred embodiment of the present invention relates to a composition of the type described above, in which the additional component, as halogenated dihydroxydiphenyl methane, dihydroxydiphenyl sulfide and dihydroxydiphenyl ether, is selected from among 5,5′-dichloro-2,2′-dihydroxydiphenyl methane, 3,5,3′,5′-tetrachloro-4,4′-dihydroxydiphenyl methane, 3,5,6,3′,5′,6′-hexachloro-2,2′-dihydroxydiphenyl methane, 5,5′-dichloro-2,2′-dihydroxydiphenyl sulfide, 2,4,5,2′,4′,5′-hexachlorodihydroxydiphenyl sulfide, 3,5,3′,5′-tetrachloro-2,2′-dihydroxydiphenyl sulfide, 4,4′-dihydroxy-2,2′-dimethyl-diphenyl methane, 2′,2-dihydroxy-5′,5-diphenyl ether or 2,4,4′-trichloro-2′-hydroxydiphenyl ether.

These phenols are available as 5,5′-dichloro-2,2′-dihydroxydiphenyl methane (Preventol DD, Bayer A G), 3,5,3′5′-tetrachloro-4,4′-dihydroxydiphenyl methane (Monsanto Corporation), 3,5,6,3′5′6′-hexachloro-2,2′-dihydroxydiphenyl methane (hexachlorophene), 5,5′-dichloro-2,2′-dihydroxydiphenyl sulfide (Novex, Boehringer Mannheim), 2,4,5,2′4′,5′-hexachloro-dihydroxydiphenyl sulfide, 3,5,3′,5′-tetrachloro-2,2′-dihydroxydiphenyl sulfide (Actamer, Monsanto), 4,4′-dihydroxy-2,2′-dimethyldiphenyl methane, 2′,2-dihydroxy-5′,5-diphenyl ether (Unilever), 2,4,4′-trichloro-2′-hydroxydiphenyl ether (Irgasan DP 300, Ciba-Geigy).

Another preferred embodiment of the present invention relates to a composition of the type described above, in which the phenol is 2,4,4′-trichloro-2′-hydroxydiphenyl ether.

Another preferred embodiment of the present invention relates to a composition of the type described above, in which the additional component is cationic, anionic or non- ionic deacetylated chitosans and chitosan derivatives, preferably trimethyl chitosanium chloride, dimethyl-N-_{C2-C12}-alkyl chitosanium iodide, quaternary chitosan salts with anions of phosphoric acid, O-carboxymethyl chitin sodium salts, O-acyl chitosan, N,O-acyl chitosan, N-3-trimethyl ammonium-2-hydroxypropyl-chitosan and O-TEAE-chitin iodide.

Another preferred embodiment of the present invention relates to a composition of the type described above, in which the chitosans and chitosan derivatives are low-molecular chitosans and chitosan derivatives, whereby the molecular weights are between 1.0×10⁵ g/mol and 3.5×10⁶ g/mol, preferably between 2.5×10⁵ g/mol and 9.5×10⁵ g/mol.

Another preferred embodiment of the present invention relates to a composition of the type described above, in which the additional components are quaternary ammonium salts of alkylated phosphoric acid, whereby each of the alkyl radicals, independently of each other, has 1 to 12 carbon atoms and/or halogenated ammonium salts, preferably cetyltrimethylammonium bromide, didecyldimethylammonium chloride, hexadecyl pyridinium chloride and polyoxyalkyl trialkyl ammonium chloride. The biostatic effect of these substituted quaternary ammonium salts of alkylated phosphoric acid has been documented in numerous publications. Owing to the very good water solubility of these salts, their incorporation into the TiO₂ matrix is particularly advantageous. Halogenated quaternary ammonium salts such as cetyltrimethylammonium bromide have proven their antimicrobial effect and can be employed in the TiO₂ matrix.

Another preferred embodiment of the present invention relates to a composition of the type described above, in which the additional components, here the microbial active substances, are present at mixing ratios between 0.1% and 99.9% by weight, preferably between 1% and 99% by weight, especially between 5% and 95% by weight.

The mixing ratio of the additional components, here the antimicrobial active substances chitosan, 2,4,4′-trichloro-2′-hydroxydiphenyl ether (Triclosan) and quaternary ammonium salts in the sols, should be set as follows with respect to each other: in total, the antimicrobial active substances can make up between 0.1% and 50% by weight, preferably between 1% and 20% by weight, relative to the total composition of the sols. The percentage of each of the antimicrobial active substances here can be between 1 vol-% and 98 vol-%. Different formulations (percentages) can be used to adjust the antimicrobial effect to the microbe population in question with an eye towards attaining the greatest effect.

Another preferred embodiment of the present invention relates to a composition of the type described above, also containing conventional auxiliaries and additives, especially acidic and alkaline polycondensation catalysts and/or fluoride ions and/or complexing agents, especially β-diketones.

Nanoscale Coating on Substrates

The invention is also based on the objective of creating a nanoscale and antimicrobial, especially biocidal, coating on the basis of an inorganic polymerized titanium dioxide on any desired organic or inorganic substrates, which, unlike the coatings known from the state of the art, are not porous and moreover, are hydrophobic as well as oleophobic.

This objective is achieved by the combination of the titanium-dioxide-producing agent together with specific amounts of other components.

Therefore, the invention also relates to a nanoscale coating, especially with a thickness of 30 nm to 500 nm, preferably between 50 nm and 250 nm, containing an inorganic polymerized TiO₂ coating that is a applied onto a substrate material, whereby the coating contains 0.1% to 49% by weight, preferably 1% to 30% by weight, especially 2% to 20% by weight, relative to the total composition, of at least one additional component that is selected from among connective tissue protein, chitosans, phenols and/or substituted quaternary ammonium salts of alkylated phosphoric acid.

Advantages of the Coatings According to the Invention

The coatings according to the invention display a high coating elasticity, along with a small coating thickness and high mechanical stability. The use of TiO₂ or of compositions containing primarily TiO₂ translated, among other things, into enhanced abrasion resistance in comparison to coatings containing pure SiO₂. The coating thicknesses according to the invention are preferably within the range from 50 nm to 100 nm.

Preferred Embodiments

According to a preferred embodiment, up to 40 parts by weight, preferably 30 parts by weight, especially 20 parts by weight, of the 100 parts by weight of the TiO₂ have been replaced by SiO₂ in the TiO₂ coating.

Coating of Hard Surfaces

According to another preferred embodiment, this coating is suitable for hard surfaces, preferably for metal, ceramic and/or plastic or elastomer surfaces, especially those made of iron-based alloys or copper-based alloys. This coating exhibits good anti-fouling properties, particularly when these surfaces come into contact with fluids and moisture.

Examples of copper-based alloys are copper alloys containing at least 50% by weight of copper, whereby the main alloying constituent is selected from among zinc, tin, aluminum, lead and/or nickel. Like copper itself, the alloys are preferably present in the above-mentioned modifications in a fine-particled form or else comminuted. The alloying powders are available, for instance, from the Carl Schenck AG company, of Roth, Germany. Preference is given to copper alloys consisting of 55% to 99% by weight, preferably 55% to 90% by weight, of copper and 1% to 45% by weight, preferably 10% to 45% by weight, of zinc, for instance, brass, lead-free, having a zinc content between 28% and 40% by weight, special brass having a zinc content of 35% to 45% by weight, soldering brass having a zinc content of 37% by weight, brass having a zinc content of 36% by weight according to German standard DIN 2.0335=MS63 or a medium red tombac having a zinc content of 15% by weight, red tombac having a zinc content of 10% by weight. In this context, we hereby make reference to Ullmanns Enzyklopädie der technischen Chemie [Ullmann's Encyclopedia of Industrial Chemistry], 4^{th} Edition, Volume 15, 1978, page 549f and to Lueger Lexikon der Technik [Lueger technical encyclopedia], Volume 3, 1961, page 445f Likewise preferred are copper alloys consisting of 60% to 99% by weight, preferably 90% to 99% by weight, of copper and 1% to 40% by weight, preferably 1% to 10% by weight, of tin, for instance, cast bronze with 10% by weight of tin or tin bronze CuSn₆ according to DIN 2.0740 BEDRA Ns18 (=bronze). We hereby make reference to Ullmann, loc. cit., page 551, and to Lueger, loc. cit., page 93. Likewise preferred are copper alloys consisting of 56% to 95% by weight, preferably 75% to 95% by weight, of copper and 5% to 44% by weight, preferably 5% to 25% by weight, of nickel, for example, a copper-nickel alloy with 16% to 25% by weight of nickel, especially CnNi₄₀ (constantan), CuNi₃₀ (used in the coin for the German Mark), CuNi₂₅ or nickel bronze with 5% to 10% by weight of nickel. We hereby make reference to Ullmann, loc. cit., page 552f Preference is also given to copper alloys consisting of 82% to 95% by weight, preferably 90% to 95% by weight, of copper and preferably 5% to 18% by weight, of aluminum, for instance, copper-aluminum wrought alloy CuAl₅ and CuAl₁₈ or else aluminum bronze with 5% to 10% by weight of aluminum. We hereby make reference to Ullmann, loc. cit., page 553f and to Lueger, loc. cit., page 408f Likewise preferred are copper-zinc-nickel alloys consisting of 50% to 70% by weight of copper, 15% to 40% by weight of zinc and 10% to 26% by weight of nickel (nickel silver), for instance, CuNi₁₂Zn₂₄, CuNi₁₈Zn₂₀ (DIN 2.0740) or CuNi₂₅Zn₁₅, or else 75% to 81% by weight of copper, 10% to 21% by weight of zinc and 1% to 9% by weight of nickel (nickel brass). We hereby make reference to Ullmann, loc. cit., page 552. Preference is also given to copper alloys consisting of 80% to 96% by weight of copper and 4% to 20% by weight of lead, the special bronzes. Preference is also given to ternary alloys such as brass containing lead (58% to 60% by weight of copper, 38% to 41% by weight of zinc and 1% to 2% by weight of lead), tin bronze (92% to 95% by weight of copper, 4% to 7% by weight of tin and 1% by weight zinc), for example, CuSn₄Zn₁, the former 2-pfennig German coins, cast brass (65% by weight of copper, 32% by weight of zinc and 3% by weight of lead), aluminum nickel bronze=bronzital (92% to 93% by weight of copper, 2% to 6% by weight of nickel and 2% to 6% by weight of aluminum). We hereby make reference to Ullmann, loc. cit., page 549f.

According to another preferred embodiment, the substrate material contains a stainless steel, a chromium steel, a chromium-nickel steel, a chromium-nickel-molybdenum, a duplex stainless steel, a TRIP steel or a copper bronze or brass or red brass.

According to another preferred embodiment, the substrate material contains heavy metals with an antibacterial effect such as, for example, copper, silver, their alloys and their compounds. The effect of these heavy metal extends through the coating all the way to the surface of the substrate material.

Coating of Organic Materials

Another objective of the present invention is to put forward a coating for organic materials.

This objective is achieved by the features of claim 19.

According to another preferred embodiment, the substrate material contains organic materials, especially wool, cotton (cellulose), textiles, paper, paperboard, natural sponge, synthetic sponge, leather, wood, cardboard and plastics.

Coating for Packaging

Another objective of the present invention is to put forward a coating for packaging aimed at protecting packaging such as cardboard on the basis of paper or paperboard as well as on the basis of textiles and also all kinds of fabrics against rain, snow, condensation, seawater, extremely high relative humidity and microorganisms, while, at the same time, retaining the breathability (diffusion capacity) on the basis of ultrathin TiO₂ coatings.

This objective is achieved by the features of claim 20.

According to another preferred embodiment, the coating is present in the form of packaging coating.

Coating of Inorganic Materials

Another objective of the present invention is to put forward a coating for inorganic materials.

This objective is achieved by the features of claim 12.

According to another preferred embodiment, the substrate material contains inorganic materials, especially metal, glass, carbon materials with and without epoxy resin impregnation, artificial stone such as concrete, bricks, tiles, facades, stucco and plaster, sintered ceramics and injection-molded ceramics such as SiC.

Coating of Composite Materials

Another objective of the present invention is to put forward a coating for composite materials.

This objective is achieved by the features of claim 22.

According to another preferred embodiment, the substrate material contains composite materials such as fiberglass-reinforced synthetic fabric and/or metal-synthetic fabric.

Coating of Synthetic Fibers, Microfibers, Felts and Fabrics

Another objective of the present invention is to put forward a coating for synthetic fibers, microfibers, felts and fabrics.

This objective is achieved by the features of claim 23.

According to another preferred embodiment, the substrate material contains synthetic fibers, microfibers, felts and fabrics, especially those made of polyester, polypropylene, high-density polyethylene, low-density polyethylene, polyacrylonitrile, polyamide, polyimide, polyaramid, aramid, meta-aramid, para-aramid, polytetrafluorethylene, polyvinylidene fluoride, polyvinylidene chloride, polyphenylene sulfide, polyphenylene ether, polystyrene, polymethyl methacrylate, polymethacrylate, polybutylene terephthalate, polycarbonate, polycarbonate acrylonitrile butadiene styrene and their composites.

Coating of Elastomeric Compounds

Another objective of the present invention is to put forward a coating for elastomeric compounds.

This objective is achieved by the features of claim 24.

According to another preferred embodiment, the substrate material contains elastomeric compounds with fillers, especially EPDM, FKM, EPDM containing silicone, NBR, HNBR, FFKM, NR, SBR, CR, silicone, IIR, AU, CSM, EVM, EU, TPE-A, TPE-E, TPE-O, TPE-S, TPE-V, TPU.

Production of the Coating

1^{st} Production Method

The present invention also has the objective of putting forward a first method for the production of the coating described above.

Therefore, the invention relates to a method for the production of a coating of the type described above, whereby, in a first process step, a sol-gel with nanoscale particles is formed in a familiar manner by means of the hydrolysis of a precursor in water and, in a second process step, the additional components dissolved or dispersed in a hydrophilic solvent are added as described above and, if applicable, temperature conditioning is carried out in a third process step.

Here, it is preferred for the precursor to be selected from among the group consisting of tetramethyoxy orthotitanate, tetraethoxy orthotitanate, tetrapropoxy orthotitanates, tetra-t-butoxy orthotitanate, tetra-n-hexadecan-1-ol-oxyorthotitanate and tetra-n-dodecan-1-ol-oxyorthotitanate, to which up to 40% by weight of tetra-methoxy orthosilicate or tetraethoxy orthosilicate, relative to the total content of TiO₂, have been added, and for the reaction to be carried out for 0.5 to 72 hours at temperatures ranging from 5° C. to 70° C. [41° F. to 158° F.].

It is likewise preferred for the hydrophilic solvent to be selected from water and/or linear or branched alcohols having up to 6 carbon atoms, especially alcohols containing water, or water.

2^{nd} Production Method

The present invention also has the objective of putting forward a second method for the production of the coating described above.

Therefore, the invention relates to a method for the production of a coating of the type described above, whereby, in a first process step, a sol-gel with nanoscale particles is formed by admixing the precursor with a buffered organic solvent at room temperature in the absence of oxygen and, in a second process step, the additional components of the above-mentioned type, dissolved or dispersed in a hydrophobic solvent, are added to the sols and, if applicable, temperature conditioning is carried out in a third process step.

According to a preferred embodiment, this method is configured in such a way that the precursor is selected from among the group consisting of tetramethyoxy orthotitanate, tetraethoxy orthotitanate, tetrapropoxy orthotitanates, tetra-t-butoxy orthotitanate, tetra-n-hexadecan-1-ol-oxy orthotitanate and tetra-n-dodecan-1-ol-oxyorthotitanate, to which up to 40% by weight of tetramethoxy orthosilicate or tetraethoxy orthosilicate, relative to the total content of TiO₂, have been added, and that the reaction is carried out for 0.5 to 100 hours at temperatures ranging from 70° C. to 220° C. [158° F. to 428° F.] and at 0.5 bar to 5 bar excess pressure.

It is likewise preferred that, in this method, the hydrophobic solvent is high-boiling and stabilizing, especially it is octadecane, and/or it has a nanoscale physical-chemical interaction, especially it is benzyl alcohol or benzyl amine, and/or that the stabilization is carried out in a familiar manner by means of centrifugation, decanting and washing or in-situ or else postsynthetically by adding stabilizers, particularly fatty acids.

Application of the Coating

The present invention also has the objective of putting forward a method for the application of the coating.

Therefore, the invention also relates to a method for applying the coating composition onto substrate materials of the type described above, which is done by contacting the surface, especially by spraying, dipping, spinning, brushing, casting, padding, film-casting or using a spray bar with at least one spray nozzle. The coating or surface-finishing can be done by familiar methods such as spray coating, dip coating, spin coating, brushing, casting. Techniques that are likewise possible and proven include industrial coating methods such as padding, also film-casting equipment, spray bars with one or more spray nozzles.

Finally, the present invention relates to various ways to use the coating composition.

Anti-Fouling Agents

Another objective of the present invention is to put forward a novel anti-fouling coating which overcomes the drawbacks of comparable coatings according to the state of the art, which has hydrophobic and oleophobic properties, thus providing effective protection of at-risk surfaces against the adhesion of biopolymers and microorganisms, while, at the same time, being environmentally friendly and which, for purposes of attaining lasting protection, is abrasion resistant and thus safe for the water.

This objective is achieved by the features of claim 27.

Therefore, the present invention relates to the use of the coating composition described above as an anti-fouling agent and biocide for surfaces that are in contact with aqueous and non-aqueous fluids.

Owing to its polymerized TiO₂ matrix, the coating is glass-like. This results in a high hydrodynamic efficiency and thus in an effective self-cleaning effect when it is used in moving water. Furthermore, the TiO₂ matrix renders the coating abrasion-resistant, scratch-resistant and wear-resistant.

Inner Coating of Containers

Moreover, the coating composition according to the invention can be used as an inner coating for containers, technical equipment, especially devices for pumping fluids, heat exchangers, evaporative coolers, boiler pipes, heating surfaces, spray absorbers, spray dryers, cooling aggregates, smokestacks made of metal, catalysts, turbines, fans, reactors, silos for food products, cement silos, lime silos, coal silos, membrane-type expansion tanks.

Flow-Conducive Coatings

Furthermore, the coating composition according to the invention can be employed as a flow-conducive coating, whereby the applied coating imparts the substrate with hydrolyzing properties.

Packaging Coating

Another objective of the invention is to use the coating on or in packaging.

This objective is achieved by the features of claim 36.

Thus, the coating composition according to the invention and of the type described above can be used on or in packaging such as cardboard packaging on the basis of paper or paperboard as well as on the basis of textiles and woven or knit fabrics.

Corrosion Protection

The present invention also relates to the use of the coating composition described above as protection against glass corrosion of glass surfaces, especially windows, glass doors, structural elements and facade elements made of glass.

The present invention also relates to the use of the coating composition described above as corrosion protection and wear-protection on metallic surfaces.

Protective Coating

The present invention also relates to the use of the coating composition described above as a protective coating on the inner of surface of refrigerators, freezers and cooling chambers, especially in commercial meat-cutting and meat-processing plants.

The present invention also relates to the use of the coating composition described above as a protective coating for surfaces in commercial or private facilities, especially in hospitals, retirement homes, meat-processing plants, food-production facilities, industrial kitchens and in vehicles, especially in passenger cars, trucks, airplanes, buses, ships, trains and streetcars.

The present invention also relates to the use of the coating composition described above as a protective coating for wallpaper, phones and keyboards.

The present invention will be described in greater detail in the figures.

The following is shown:

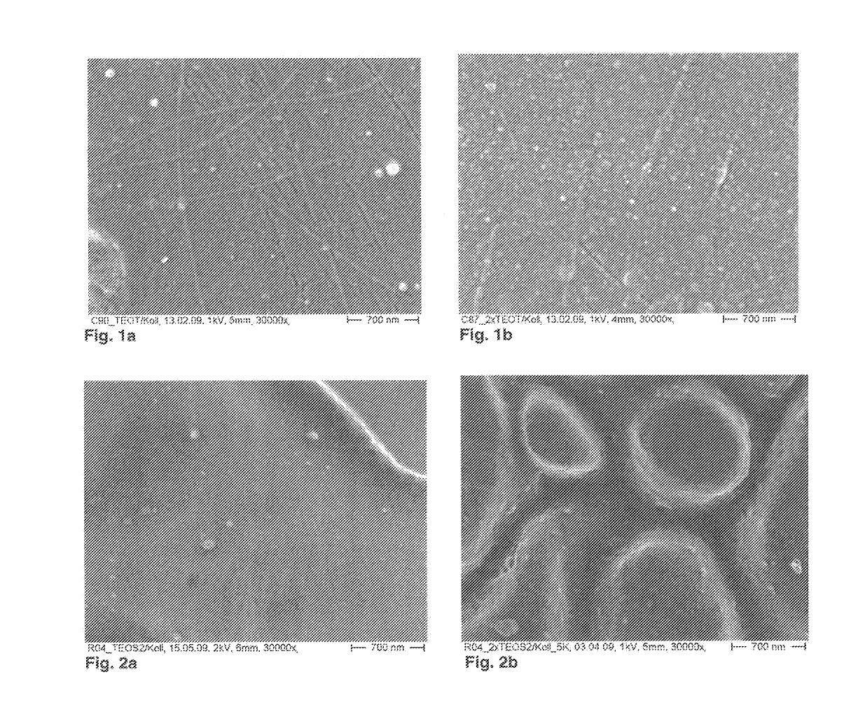

FIG. 1a: an electron-microscopic image of a TEOT coating (with 15% by weight of collagen from Chondrosia reniformis N) on a CuSn₆ plate, coated once.

FIG. 1b: an electron-microscopic image of a TEOT coating (with 15% by weight of collagen from Chondrosia reniformis N) on a CuSn₆ plate, coated twice.

FIG. 2a: an electron-microscopic image of a TEOT coating (with 15% by weight of collagen from Chondrosia reniformis N) on a CrNi steel plate, coated once.

FIG. 2b: an electron-microscopic image of a TEOT coating (with 15% by weight of collagen from Chondrosia reniformis N) on a CrNi steel plate, coated twice.

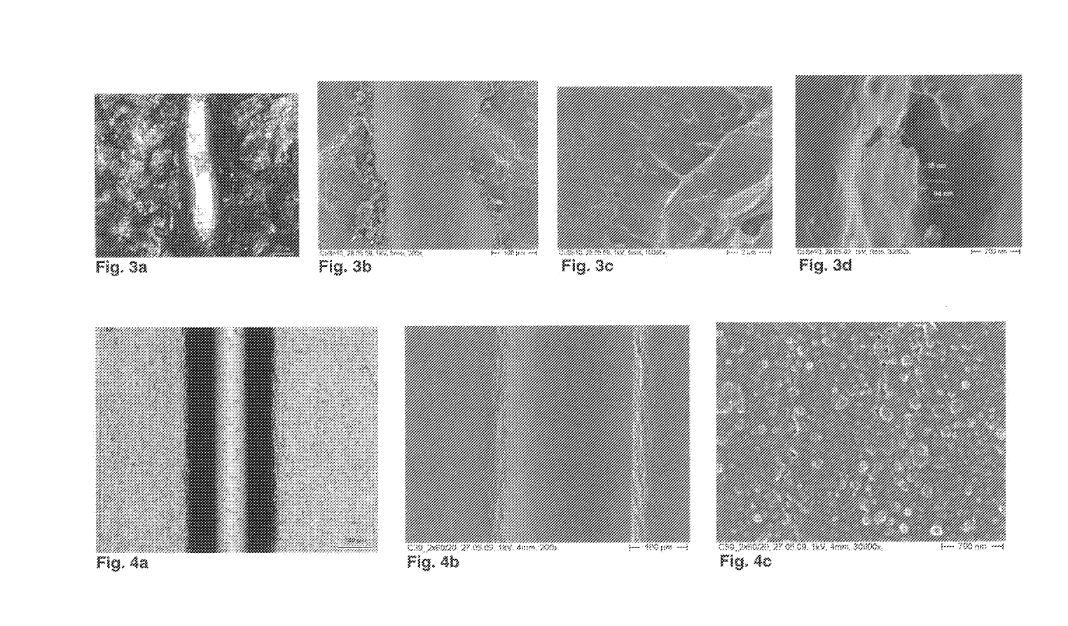

FIGS. 3a to 3d: light-microscopic and electron-microscopic images of a TEOT coating (with 15% by weight of collagen from Chondrosia reniformis N), coated once, scratch test.

FIGS. 4a to 4c: light-microscopic and electron-microscopic images of a coating (80%TEOT/20%TEOS) (with 15% by weight of collagen from Chondrosia reniformis N) on CuSn₆, coated twice, scratch test.

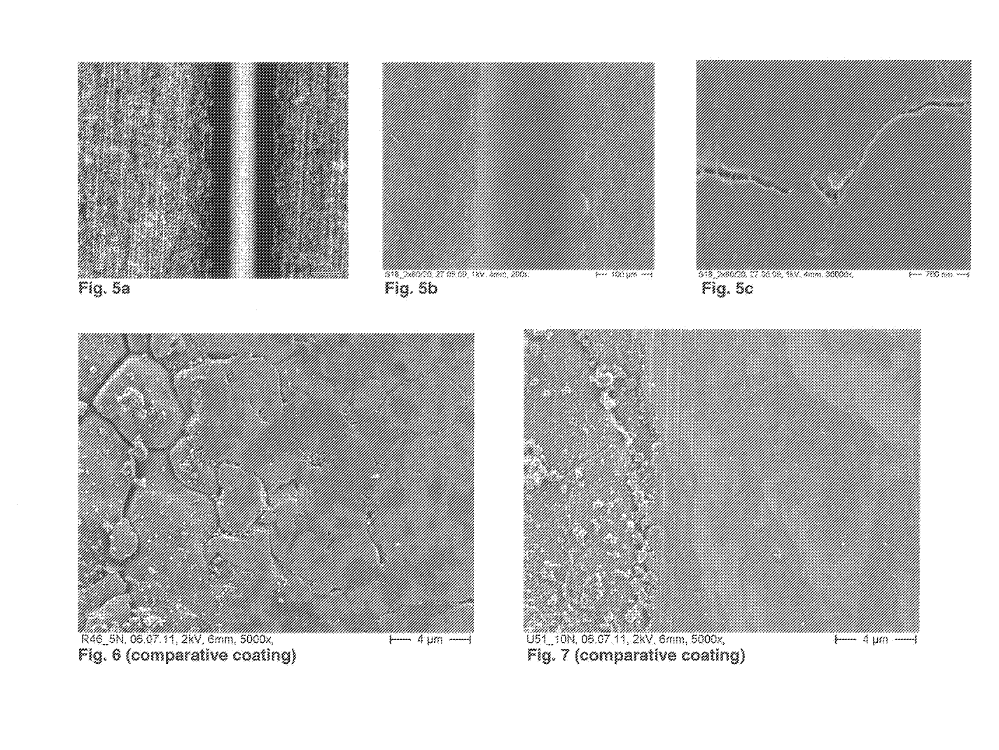

FIGS. 5a to 5c: light-microscopic and electron-microscopic images of a coating (80%TEOT/20%TEOS) (with 15% by weight of collagen from Chondrosia reniformis N) on CrNi steel, coated twice, scratch test.

FIG. 6: an electron-microscopic image of a TEOT coating on a CrNi steel plate (for comparison purposes).

FIG. 7: an electron-microscopic image of a TEOT coating on a CuSn₆ plate (for comparison purposes).

FIGS. 8a to 8c: light-microscopic and electron-microscopic images of a coating (TEOT/chitosan) on CrNi steel.

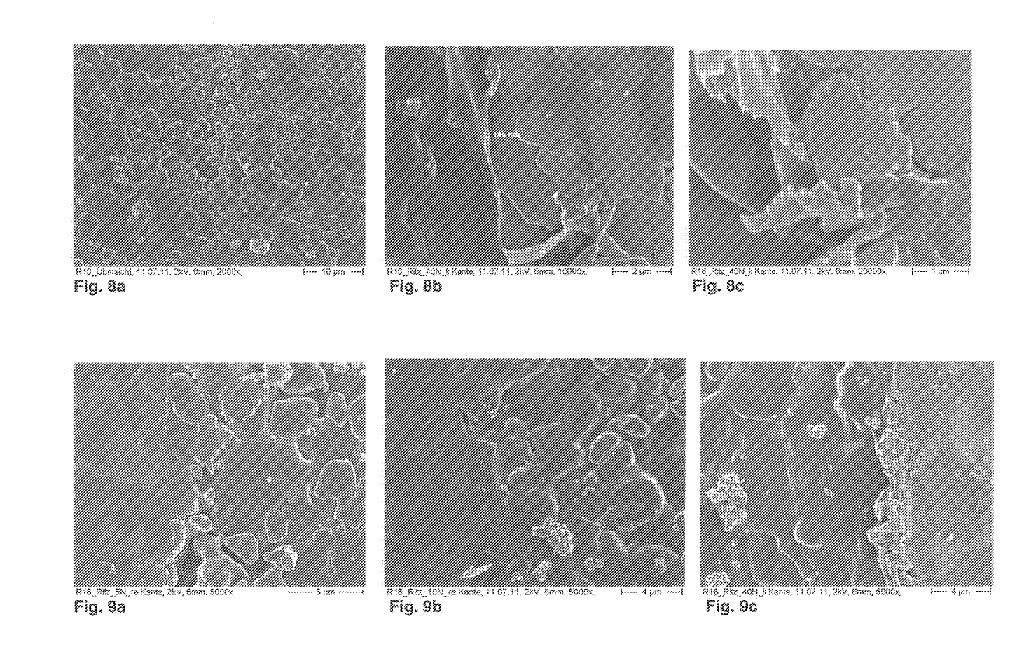

FIGS. 9a to 9c: light-microscopic and electron-microscopic images of a coating (TEOT/chitosan) on CrNi steel, scratch test.

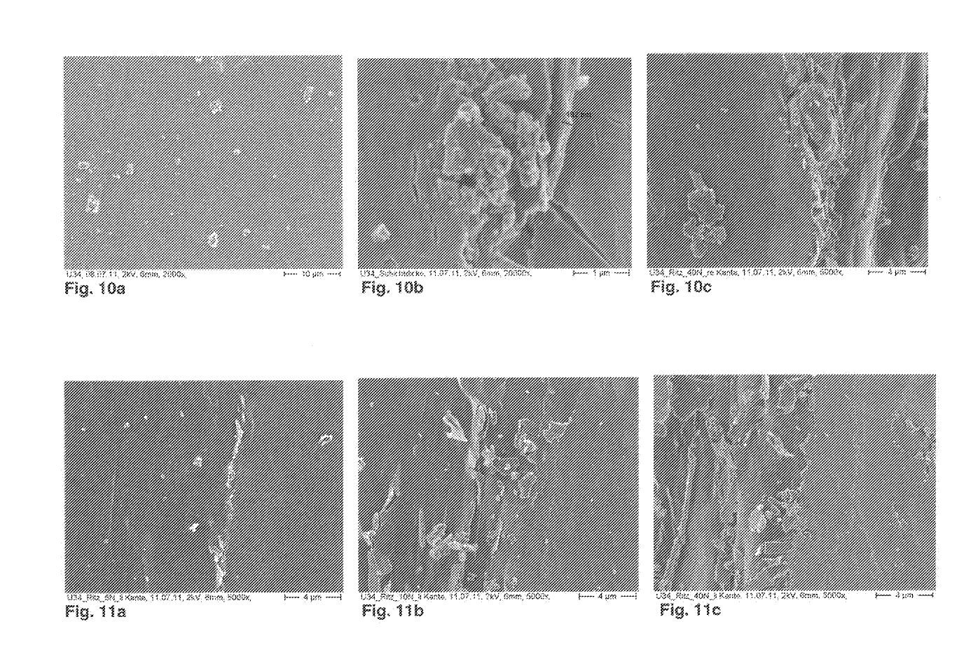

FIGS. 10a to 10c: light-microscopic and electron-microscopic images of a coating (TEOT/chitosan) on a CuSn₆ plate.

FIGS. 11a to 11c: light-microscopic and electron-microscopic images of a coating (TEOT/chitosan) on a CuSn₆ plate, scratch test.

FIG. 1a shows an image of a TEOT coating on a CuSn₆ plate that has been coated once, while FIG. 1b shows an electron-microscopic image of a TEOT coating on a CuSn₆ plate that has been coated twice. One can see a much rougher structure in comparison to the steel plate according to FIG. 2a and FIG. 2b.

FIG. 2a shows an image of a TEOT coating on a CrNi steel plate 1.4404 that has been coated once, while FIG. 2b shows an image of a TEOT coating on a CrNi steel plate that has been coated twice.

FIG. 3a shows a light-microscopic image and FIG. 3b shows an electron-microscopic image of a notch scratched into cast tin-bronze (CuSn₁₀) that has been coated once with TEOT. It can be seen that the substrate is not very deformable, and that abraded particles are present at the edge of the scratch tracks. FIG. 3c shows the coating thickness and FIG. 3d shows the coating surface as an electron-microscopic image of the same specimen. It can be seen that the coating adapts to the rough cast surface. The coating thickness is less than 100 nm and varies due to the irregularities.

FIG. 4a shows a light-microscopic image and FIG. 4b shows an electron-microscopic image of a notch scratched into cast bronze (CuSn₆) that has been coated twice with 80% TEOT and 20% TEOS. It can be seen that the coating adapts to the deformations of the substrate. The electron-microscopic image according to FIG. 4c shows that the collagen fibers are still visible in the bed of the notch.

FIG. 5a shows a light-microscopic image and FIG. 5b shows an electron-microscopic image of a notch scratched into a CrNi steel plate 1.4404 that has been coated twice with 80% TEOT and 20% TEOS. It can be seen that the coating adapts to the deformation of the substrate. The electron-microscopic image according to FIG. 5c shows that the collagen fibers are still visible in the bed of the notch.

The present invention will be described in greater detail below by means of embodiments in the form of production examples and application examples.

### Embodiment

Substrate Material

The substrate materials selected were austenitic, corrosion-proof steel bearing material number 1.4404 and a rollable bronze alloy CuSn₆ which serves as the comparison material for the cast tin bronze CnSn₁₀ used as the material for the housing. The substrate materials were present in the form of rolled plates. The test plates underwent cleaning in an ultrasound bath with ethanol.

Coating Systems

Three different base sols were prepared using the following alkoxides: tetraethoxy orthosilicate TEOS*, tetramethoxy orthosilicate TMOS* and tetraethoxy orthotitanate TEOT, each available from Merck KGaA, of Darmstadt, Germany. The formulation specification for the base sols is the following: 1.5 ml of alkoxide are prepared and hydrolyzed with 36 ml of 0.01 M HCl under agitation (10 minutes to 2 hours). This base sol is mixed at a ratio of 1:1 with a TRIS/HCl buffer solution containing collagen. The formulation specification is given below: *)for comparison purposes (state of the art)

1) Preparation of sol containing collagen:
coating sol = base sol + collagen solution

| | | Agitation parameters | | |
|---|---|---|---|---|
| | | Time | Speed | Temperature |
| Solutions | Substances | (min) | (rpm) | ° C. [° F.] |
| Coating sol | 17 ml collagen | 10 | 500 | 20 [68] |
| | solution + 17 ml | | | |
| | base sol | | | |
| Base sol | 1.5 ml collagen + | TEOT: 10 | 1000 | 20 [68] |
| | 36 ml 0.01M HCl | TEOS: 120 | | |
| Collagen | 700 mg collagen + | 2880 | 500 | 4 [39.2] |
| solution | 100 ml TRIS-HCl | | | |
| | buffer | | | |
| | (1.8 g TRIS | | | |
| | (granules) + 97.5 | | | |
| | ml distilled H₂O + | | | |
| | 2.5 ml 2M HCl) | | | |

alkoxide (Merck company):
TEOS C₈H₂₀O₄Si 208.33 g/mol;
1 liter = 0.94 g
TEOT C₈H₂₀O₄Ti 228.15 g/mol;
1 liter = 1.08 g

2) Coating parameters of the dip coating:

| | |
|---|---|
| one-time coating: | 0.3 mm/s drawing speed |
| two-time coating: | 1) 0.3 mm/s drawing speed/drying in air at |
| | room temperature |
| | 2) 0.3 mm/s drawing speed |

3) Temperature treatment:
60° C. [140° F.]/60 min in a pre-heated drying cabinet

This yielded a mixture of 85% by weight of TEOT and 15% by weight of collagen.

The collagen from Chondrosia reniformis N was obtained from KliniPharm GmbH, of Frankfurt am Main, Germany. The material was present in frozen, compressed form. The material was purified several times in TRIS buffer and homogenized under prolonged, continuous agitation for 48 hours. It was subsequently present in dissolved form and available for further use.

Preparation of a Collagen-Stabilized Mixed Sol

The addition of coating components containing titanium oxide to the coating component containing silicon dioxide was expected to bring about a marked rise in the wear-resistance of these sol-gel coatings.

In order to further increase the mechanical coating stability, these coatings were made by means of the two-time dip-coating technique, whereby both coatings consisted of the appertaining sol containing collagen. These coatings were characterized in terms of their mechanical properties as well as their biological efficacy. FIGS. 1a and 1b show the sol-gel coating with TEOT on the bronze substrate, while FIGS. 2a and 2b show the coatings on the CrNi steel 1.4404. The coatings form fundamentally different coating morphologies, depending on the substrate material. The surface of the sol-gel coating on the bronze plate is much rougher than the one on the CrNi plate.

Evaluation of the Coating Properties

Mechanical Evaluation of the Coating Adhesion by Means of a Scratch Test

The test involved series of increasing loads up to a maximum load of 40 N. According to the standard, the test specimen was a diamond stylus having Rockwell-C geometry [DIN EN 1071-3]. The scratch-test device was employed to apply a constant load of 40 N over a scratch length of 23 mm at the standardized speed of 10 mm/min. The scratch tracks were evaluated by means of optical methods.

According to the standard, the evaluation of the failure mechanism of the coatings in the scratch test was based on an evaluation by means of light microscopy. Minimal loads that lead to the first instance of crack formation in the coating or to the first instance of chipping of the coating were evaluated. However, only scanning electron-microscopic images allow a reliable evaluation of the failure details in the bed of the notch as well as of peeling of the coating and different wear behavior. FIGS. 4 and 5 show and explain the results of the scratch test on the coatings for both substrate materials by way of example, namely, CrSn₆ and CrNi steel 1.4404. In both cases, the coating and the substrate can be deformed in such a way that the prevalent appearance is a scratch track having deformation flanks on the sides. Neither light microscopy nor electron microscopy were able to show any cracks in, or chipping of, the thin coatings. At a high magnification, even collagen fibers appeared at times in the scratch track. If the basic material can be readily plastically deformed, then the coating can adapt to the changed geometric conditions over a wide range. This very good adaptation of the coatings to the load was ascertained for the one-time coatings and two-time coatings containing collagen.

Deviations were found in a comparison with the material used for the pump housings, namely, cast tin bronze CuSn₁₀. The bronze cast material was coated employing a one- time dip-coating technique with TEOT containing collagen. The coating again adapted very well to the uneven cast surface (FIG. 3). Tin bronzes, however, are considerably more brittle than rollable bronze alloys. In the scratch test at the normal force of 40 N, this material was not very deformable. Abraded particles came off, a few of which could be found sporadically on the edge of the scratch track. This wear behavior on the part of the basic material causes the coating in the area of the scratch to rupture.

Evaluation of the Biological Efficacy

Luminescent Bacteria Test

The luminescent bacteria test according to Dr. Lange was employed in order to evaluate the ecotoxicological potential of the natural sponge collagens employed. This test determines the inhibition of light emission by the marine bacterium species Vibrio fischeri. A dilution series involving nine dilution stages of the active substance to be examined is prepared whose toxic effect should appear in the form of luminescence inhibition of the bacteria. The EC₂₀ and EC₅₀ values are determined according to the standard. These values correspond to the dilution stages which, in comparison to a test solution containing bacteria without an active substance, result in luminescence inhibition of 20% and 50%, respectively. The procedures were carried out according to international standard ISO 11348-2, whose execution requires the use of liquid-dried Vibrio fischeri bacteria. The bacteria preparation was obtained from the Dr. Lange company. Tables 3 to 5 show the test results according to the standard. Two sponge collagen-TRSI/HCl solutions prepared independently of each other were tested. The sponge collagen used was a natural biocidal substance stemming from Chondrosia reniformis, which can be present in the collagen solution at varying concentrations. The collagen solutions were prepared in the usual manner. They were extensively filtered in order to be examined within the scope of this luminescent bacteria test since turbidity has a markedly negative effect on the measurement of the luminescence intensity. The toxic effect was determined mainly as a function of the exposure time/incubation time of the bacteria in the test solution. The maximum incubation time within the scope of the examinations presented was 140 minutes. The value of the critical luminescence inhibition results from a linear regression of the inhibition effects calculated as a function of the appertaining dilution stage. The lower limit of the non-toxic active-substance concentration EC₂₀ was found to be 3 mg/ml on the basis of all of the tests but the results diverge markedly from this in individual cases. Diagrams 1 and 2 graphically illustrate the change in the luminescence inhibition of the bacteria as the incubation time in the test solution progresses. As expected, an increase in luminescence inhibition is observed as the dilution of the test solution decreases. However, if one follows the tendency of the sol batch of March 2009, Test 1, a rise in the ecotoxicological potential of the test solution is only observed at all as the concentration of the active substance increases. At a low concentration of toxic active substances, the luminescence inhibition drops as the dilution of the test solution decreases. As the incubation time progresses, luminescence inhibition of the bacteria sets in and the limit of 20% is exceeded by this sol batch at an active-substance concentration of 4.8 mg/ml. In the case of the same sol batch from March 2009, Test 2, a critical luminescence inhibition of 20% was likewise ascertained at an active-substance concentration of 4.8 mg/ml. The critical dilution of the test solution diminishes as the incubation time of the bacteria in the test solution progresses. A critical luminescence inhibition EC₅₀, which causes a 50% luminescence inhibition, did not occur in these tests.

Luminescent bacteria test according to Dr.
Lange, sol batch of October 2008, Test 1.

| Dilution | % inhibition | % inhibition | % inhibition |
|---|---|---|---|
| stage | after 30 | after 60 | after 90 |
| [mg/ml] | minutes | minutes | minutes |
| 0.44 | 18.23 | 4.42 | 10.50 |
| 0.58 | 20.00 | 6.49 | 13.41 |
| 0.88 | 19.86 | 6.75 | 13.16 |
| 1.17 | 21.17 | 9.10 | 17.05 |
| 1.75 | 4.19 | −1.35 | 8.00 |
| 2.30 | 22.68 | 12.51 | 19.03 |
| 3.50 | 12.32 | 13.84 | 20.42 |
| 4.70 | 9.02 | 16.93 | 24.11 |
| 7.00 | 8.03 | 30.05 | 36.49 |

EC₂₀

| | | |
|---|---|---|
| not | 5.00 | 3.00 |
| ascertainable | | |

Luminescent bacteria test according to Dr. Lange, sol batch of March 2009, Test 1.

| Dilution | % inhibition | % inhibition | % inhibition | % inhibition | % inhibition | % inhibition |
|---|---|---|---|---|---|---|
| stage | after 20 | after 40 | after 60 | after 80 | after 100 | after 120 |
| [mg/ml] | minutes | minutes | minutes | minutes | minutes | minutes |
| 0.44 | 23.34 | 12.16 | 13.45 | 10.84 | 10.33 | 8.74 |
| 0.58 | 22.99 | 12.77 | 13.17 | 11.44 | 11.42 | 9.68 |
| 0.88 | 27.55 | 16.82 | 20.22 | 18.32 | 16.92 | 15.26 |
| 1.17 | 27.55 | 17.10 | — | 13.19 | 17.25 | 15.60 |
| 1.75 | 23.63 | — | — | — | — | — |
| 2.30 | 18.95 | 7.32 | — | 10.01 | 9.03 | 7.18 |
| 3.50 | 21.29 | 13.53 | — | 17.54 | 18.07 | 16.77 |
| 4.70 | 19.43 | 9.81 | — | 16.37 | 14.98 | 13.92 |
| 7.00 | 25.85 | 20.25 | — | 27.58 | 26.28 | 25.22 |

EC₂₀

| | | | | | |
|---|---|---|---|---|---|
| not | none | not | 4.80 | 5.20 | 5.80 |
| ascertainable | | ascertainable | | | |

Luminescent bacteria test according to Dr. Lange, sol batch of March 2009, Test 2.

| Dilution | % inhibition | % inhibition | % inhibition | % inhibition | % inhibition | % inhibition |
|---|---|---|---|---|---|---|
| stage | after 60 | after 75 | after 90 | after 100 | after 120 | after 140 |
| [mg/ml] | minutes | minutes | minutes | minutes | minutes | minutes |
| 0.44 | −6.09 | — | −6.40 | −5.02 | −2.46 | 1.88 |
| 0.58 | −2.41 | 11.06 | −1.91 | −2.79 | 2.13 | 2.63 |
| 0.875 | −15.04 | −0.33 | −12.72 | −8.14 | −6.26 | −2.95 |
| 1.17 | −3.88 | 12.10 | −1.13 | 3.64 | 6.63 | 7.89 |
| 1.75 | 2.09 | 16.31 | 4.14 | 9.42 | 12.99 | 16.68 |
| 2.3 | −1.26 | 13.59 | 3.14 | 8.10 | 11.09 | 15.33 |
| 3.5 | 0.97 | 17.76 | 7.36 | 13.78 | 15.86 | 20.20 |
| 4.7 | 2.27 | 17.10 | 7.76 | 13.40 | 15.89 | 21.43 |
| 7 | 4.20 | 22.96 | 14.41 | 17.79 | 20.76 | 23.58 |

EC₂₀

| | | | | | |
|---|---|---|---|---|---|
| none | 5.40 | none | none | 5.80 | 4.80 |

Anti-Fouling Test

Selected specimens were subjected to a three-day anti-fouling test. The gram-negative bacterium species Pseudomonas aeruginosa was employed for this test. This species is known as an active biofilm former. After the bacteria had been killed with ethanol, they were stained with DAPI (exposure time of 15 minutes) and the bacterial population on the specimen surfaces was ascertained by means of fluorescence microscopy.

For this purpose, a Zeiss Axioskop FSmot fluorescence microscope took images of nine uniformly distributed sampling sites having a surface area of 0.58 mm² each. The area analyzed per measuring step corresponds to the light-microscopically examined surface area at a minimal, ten-fold magnification. The portion of the surface area populated by bacteria was then determined by means of grayscale analysis employing the image-processing program a4i-Analysis of the Aquinto AG company.

Whereas a bacterial population, at times covering a large surface area, can be seen on the austenitic CrNi steel plate, an extremely sparse, very sporadic punctiform population is observed on the CuSn₆ plate.

CrNi Steel 1.4404

The uncoated substrate (CrNi steel 1.4404), pure TiO₂-sol-gel two-time coatings containing collagen, and an SiO₂-sol-gel two-time coating for comparison purposes were selected (see table below). The bacterial population densities on the specimen surfaces ascertained according to the test and evaluation methods described above are likewise compiled in the table below. The efficacy of single coatings and double coatings was also examined in this context. The results of the anti-fouling tests were comparable.

Results of the anti-fouling test (Pseudomonas aeruginosa,
72 hours; substrate material: 1.4404)

| | | | Population density | |
|---|---|---|---|---|
| | Description of | Coating | (averaged over nine | |
| Coating | the coating sols | thickness | sampling sites) | σₓ |
| substrate without | — | — | 22% | 9% |
| coating | | | | |
| 2 × TEOS * | silicon alkoxide | approx. 50 nm | 17% | 8% |
| | containing collagen | | | |
| 2 × TEOT | titanium alkoxide | ″ | 14% | 6% |
| | containing collagen | | | |

* for comparison purposes (state of the art)

CuSn₆

This test series likewise examined an uncoated CuSn₆ substrate, a pure titanium dioxide sol-gel coating containing collagen and, for comparison purposes, a pure silicon-dioxide sol-gel coating containing collagen. The bacterial population densities on the specimen surfaces ascertained according to the test and evaluation methods described above can be seen below.

Results of the anti-fouling test (Pseudomonas aeruginosa,
72 hours; substrate material: CuSn₆)

| | | | Population density | |
|---|---|---|---|---|
| | Description of | Coating | (averaged over nine | |
| Coating | the coating sols | thickness | sampling sites) | σₓ |
| substrate without | — | — | 0.09% | 0.08% |
| coating | | | | |
| 2 × TEOS * | silicon alkoxide | approx. 50 nm | 0.04% | 0.08% |
| | containing collagen | | | |
| 2 × TMOS * | silicon alkoxide | ″ | 0.06% | 0.1% |
| | containing collagen | | | |
| 1 × TEOT | titanium alkoxide | ″ | 0.03% | 0.05% |
| | containing collagen | | | |
| 1 × TEOT | titanium alkoxide | ″ | 0.03% | 0.1% |
| | containing collagen | | | |

* for comparison purposes (state of the art)

Population densities of 0.1% were ascertained.

Test Parameters

| Coating systems | | TEOT (comparison) |
|---|---|---|
| examined: | | TEOT (chitosan) |
| Substrate | | CrNi steel [austenitic steel plate 1.4404] |
| material: | | bronze plate (tin bronze CuSn₆) |
| | | specimen geometry 35 mm × 25 mm |
| Coating | | dip-coating |
| parameters: | | drawing speed: 0.3 mm/s |
| | | drying in air |
| | | temperature treatment: 60° C. [140° F.]/60 minutes in a |
| | | pre-heated drying cabinet |
| Evaluation | Scratch test: | The adhesive strength of the coatings was ascertained by |
| criteria: | | means of a scratch test based on DIN EN 1071-3. For this |
| | | purpose, the specimen was scratched with a standardized |
| | | testing element, namely, a diamond stylus having |
| | | Rockwell-C geometry, at a scratching speed of 10 mm/min |
| | | at loads of 5N, 10N and 40N. The scratch tracks were |
| | | evaluated with a scanning electron microscope since the |
| | | typical macroscopic failure forms that can be examined |
| | | with a light microscope do not occur here. |
| | Anti-fouling test: | Coated specimen substrates were subjected to a two-day |
| | | dynamic anti-fouling test in a shaking test apparatus. The |
| | | anti-fouling effect was tested on Escherichia coli K12. The |
| | | specimens were each tested separately in a shake flask |
| | | containing nutrient medium since an influence of the |
| | | substrate material on the anti-fouling effect cannot be |
| | | ruled out. (The specimens exhibit a different covering |
| | | capacity of the sol coating). After the end of the exposure |
| | | time, the specimens were rinsed, fixed with formaldehyde |
| | | and stained with the DNA dye DAPI. A fluorescence |
| | | microscope was then employed to determine the portions |
| | | of the specimen surfaces populated by bacteria. Towards |
| | | this end, fluorescence images were taken at nine uniformly |
| | | distributed sampling sites on the specimen. The surface |
| | | area populated by bacteria was subsequently determined |
| | | by means of a grayscale analysis (software: a4i-Analysis/ |
| | | Aquinto company). |
| | Luminescence test: | The luminescence bacteria test according to Dr. Lange was |
| | | conducted in order to evaluate the ecotoxicological |
| | | potential. The starting solutions of the following sol |
| | | components were analyzed: TEOT, chitosan, triclosan. For |
| | | this purpose, the luminescence inhibition of the |
| | | luminescent bacteria Vibrio fischeri was determined. |
| | | According to the standard, the EC₂₀ and EC₅₀ values |
| | | (critical concentration) were ascertained, which refer to the |
| | | concentration or dilution stage of the active substance that |
| | | cause a luminescence inhibition of 20% and 50%, |
| | | respectively. |

Initial Condition: Pure TEOT Coating (Comparative Test)

Tetraethyl orthotitanate: TEOT (C₈H₂₀O₄Ti), manufacturer: Merck

a) Preparation of a TEOT Base Sol:

The TEOT base sol consists of a 4%-aqueous solution of TEOT. For this purpose, 15 ml of TEOT are prepared, 360 ml of 0.01 M HCl are added and hydrolyzed for a period of 24 hours under strong agitation.

pH value of the TEOT base sol: 2.96.

Basis for comparison: coating with pure TEOT sol.

Coating result: “TEOT base sol”

| | |
|---|---|
| Covering capacity of the drawn sol-gel | FIG. 6: substrate |
| coating: | material: V4A |
| The covering capacity of a pure TEOT base | |
| sol is insufficient. The specimens have areas | |
| in which the coating only led to the adhesion | |
| of smaller and larger agglomerates of the | |
| TEOT nanoparticles. | |
| The right-hand area of the figure below | FIG. 7: substrate |
| shows the surface areas that have been dented | material: CuSn₆ |
| by means of the scratch test. The TiO₂ | |
| nanoparticles do not appear as particles that | |
| have been pressed into the deformed area but | |
| rather, it is very likely that they have been | |
| ablated in this area due to the load exerted. | |
| Coating thickness: | cannot be determined |
| Coating elasticity: | cannot be determined |
| Anti-fouling effect: | substrate V4A: |
| Bacterial population density in the two-day | 8.7% portion of |
| dynamic E. coli test: | the surface area |
| | substrate CuSn₆: |
| | 3% portion of |
| | the surface area |

Preparation of a TEOT-Chitosan Composite

Chitosan: 85/200/A1, degree of deacetylization viscosity value as a function of molar weight measure of the amount of residue in the extraction process manufacturer: Heppe GmbH, Biologische Systeme and Materialen, of Queis, Germany pulverulent/flocculent

a) Preparation of a Chitosan Solution:

300 ml of 2.5%-acetic acid were prepared. The chitosan was mixed at a ratio of 3.6 g of chitosan in 296.4 g of acetic acid and then dissolved by means of ultrasound for a duration of 5 hours at room temperature. The result was a high-viscosity liquid having a pH value of 3.5.

Setting the pH value: [symbol] pH 4 (pH 3.5)+4 ml 1 N NaOH [symbol] pH 6 (pH 3.5)+36 ml 1 N NaOH

b) Preparation of the “Chitosan/TEOT Composite” Coating Sols:

The TEOT base sol was mixed with the appropriate chitosan solutions at the mixing ratio of 1:1. The TEOT sol was prepared (base sol 4%).

Sol 1 pH 3.71: 100 ml chitosan solution (pH 3.5)+100 ml TEOT-sol (pH 2.96)

Sol 2 pH 4.03: 104 ml chitosan solution (pH 4.04)+104 ml TEOT-sol (pH 2.96)

Sol 3 pH 6.06: 136 ml chitosan solution (pH 6.46)+136 ml TEOT-sol (pH 2.96)

Result for the “TEOT/chitosan composite” coating

Substrate material: CrNi steel V4A

| | |
|---|---|
| Covering capacity of the drawn sol-gel | FIG. 8a |
| coating: | |
| The covering capacity of this coating | |
| system is excellent. It can very precisely | |
| replicate complex substrates of the type | |
| found with rolled V4A plates. Extremely | |
| little crack formation is found, even | |
| after the drying process. | |
| Coating thickness: | FIG. 8b |
| The detectable coating thickness values | |
| are in the range from 145 nm to 200 nm. | |
| Coating elasticity: | FIG. 8c |
| One-time coating with TEOT/chitosan, | |
| deformation flank at the edge of a 40N | |
| notch. | |
| The polymer fraction in the sol brings | |
| about a good bond of the otherwise poorly | |
| covering TEOT sol that has a strong | |
| tendency towards agglomerate formation. | |
| Under marked deformation, the coatings | |
| tend to warp and to undergo ductile | |
| fracture, they do not shatter. Aciniform | |
| agglomerates of the nanoparticles of the | |
| base sol are visible at the fracture sites. | |
| Anti-fouling effect: | TEOT/chitosan, |
| Bacterial population density in the | pH 3.71: 10% portion |
| two-day dynamic E. coli test | of the surface area |
| | TEOT/chitosan, |
| | pH 4.04: 6.8% portion |
| | of the surface area |
| | TEOT/chitosan, |
| | pH 6.06: 12.7% portion |
| | of the surface area |

Scratch test of the “TEOT/chitosan composite”, substrate: CrNi steel V4A

| | |
|---|---|
| Load: 5N | FIG. 9a |
| The coating completely follows the | |
| substrate surface changed by the scratch. | |
| As can be seen in the image below, the | |
| chitosan forms partially thread-like | |
| agglomerates in the coating system. No | |
| peeling phenomena or coating tearing | |
| could be observed. | |
| Load: 10N | FIG. 9b |
| The coating completely follows the | |
| substrate surface changed by the scratch. | |
| No peeling phenomena or coating tearing | |
| could be observed or else only to an | |
| extremely low extent. | |
| Load: 40N | FIG. 9c |
| The coating is pressed into the notch bed, | |
| the load causes an initial slight crack | |
| formation in the coating in the notch bed, | |
| but does not cause peeling. In the | |
| deformation flank, which experiences | |
| strong deformation, it can be seen that the | |
| coating split into two. Individual lumpy | |
| coating components rise from the highly | |
| elastic warped substrate. | |

Result for the “TEOT/chitosan composite” coating, substrate material: CuSn₆

| | |
|---|---|
| Covering capacity of the drawn sol-gel | FIG. 10a |
| coating: | |
| The covering capacity of this coating | |
| system is excellent. Extremely little | |
| crack formation occurs, even after the | |
| drying process. | |
| Coating thickness: | FIG. 10b |
| The detectable coating thickness values | |
| are in the range from 120 nm to 200 nm. | |
| Coating elasticity: | FIG. 10c |
| One-time coating with TEOT/chitosan, | |
| deformation flank at the edge of a 40N | |
| notch. | |
| The polymer fraction in the sol brings | |
| about a good bond of the otherwise poorly | |
| covering TEOT sol that has a strong | |
| tendency towards agglomerate formation. | |
| Under marked deformation, the coatings | |
| tend to plate/chunk formation and to | |
| ductile fracture, they do not chip. | |
| Aciniform agglomerates of the | |
| nanoparticles of the base sol are | |
| visible at the fracture sites. | |
| Anti-fouling effect: | TEOT/chitosan, pH 3.71: |
| Bacterial population density in the | 1% of the surface area |
| two-day dynamic E. coli test | TEOT/chitosan, pH 4.04: |
| | 3.8% of the surface area |
| | TEOT/chitosan, pH 6.06: |
| | 1.97% of the surface area |

Scratch test of the “TEOT/chitosan composite”, substrate: CuSn₆

| | |
|---|---|
| Load: 5N | FIG. 11a |
| The coating follows the substrate surface | |
| changed by the scratch well. No coating | |
| tearing was observed at the edge. | |
| Load: 10N | FIG. 11b |
| The coating follows the substrate surface | |
| changed by the scratch. Slight coating | |
| peeling phenomena were observed. | |
| Load: 40N | FIG. 11e |
| Even at this load level, the coating can be | |
| incorporated into the notch bed. However, | |
| the coating peels off the deformation flank | |
| in the area of the greatest deformations. | |
| Under certain circumstances, cracks | |
| appear in the notch bed already in the | |
| substrate material CuSn₆, so that the | |
| coating can likewise tear as a result of this | |
| crack formation. | |

Luminescence Test with TEOT and TEOT/Chitosan Sols

Three test substances were examined within the scope of the luminescence test aimed at determining the ecotoxicological potential of the coating solution. The objective of the test was to ascertain the concentration of the examined active substance at which less than 20% luminescence-inhibition of the test bacteria Vibrio fischeri occurs. The ISO standard stipulates that an incubation time of 30 minutes must be observed between the inoculation of the test concentration solution and the measurement. Nine dilution stages were examined per test (9 measured values per series of measurements). The coating solution should be diluted until EC₂₀ is ascertained. After the sought-after dilution stage had been determined, another measurement was carried out after at least another 30 minutes had passed.

a) TEOT Sol:

In order to be able to ascertain a luminescence value, there is a need for appropriately clear test solutions. The standard suggests that filtration be carried out in order to prepare the test solution. Due to the size of the nanoparticulate alkoxides, TEOT sols are often turbid. In order to evaluate the compatibility of the nanoparticulate fraction of the solution, this test series made use of an adequately diluted sol instead of a filtered supernatant. The dimension of the specimen content corresponded to 33% of the initial sol normally used.

Result: the value already falls below the critical luminescence inhibition with the dilution stage 1 of the test series (Diagram 3).

b) Chitosan Solution:

Concentration of the active substance in the sol: 0.6 g/100 ml

Concentration of the active substance in dilution stage 1 of the test series: 1.5 g/l

Result: the value already falls below the critical luminescence inhibition after 30 minutes of incubation time at a concentration of 0.1 g/l. Deviating from the standard stipulations, a logarithmic regression was chosen here in order to better illustrate the behavior. With an incubation time of 90 minutes, the sought-after EC₂₀ was not reached, but instead, only the EC₅₀ value for the same concentration was reached (Diagram 4).

1. A coating composition containing 51% to 99.9% by weight, preferably 70% to 99% by weight, especially 80% to 98% by weight, of a TiO₂-producing agent, whereby the coating composition contains 0.1% to 49% by weight, preferably 1% to 30% by weight, especially 2% to 20% by weight, relative to the total composition, of at least one additional component selected from among connective tissue protein, chitosans, phenols and/or substituted quaternary ammonium salts of alkylated phosphoric acid.

2. The composition according to claim 1, characterized in that up to 40 parts by weight, preferably 30 parts by weight, especially 20 parts by weight of the 100 parts by weight of the TiO₂-producing agent are replaced by a silicon-dioxide-producing agent.

3. The composition according to claim 1 or 2, characterized in that this additional component is a connective tissue protein, especially collagen, elastin, proteoglycan, fibronectin or laminin, obtained from vertebrates, preferably domesticated animals, especially pigs and/or cows and/or from the phylum Porifera, preferably of the class Demospongiae, particularly of the subclass Tetractinomorpha, order Chondrosida.

4. The composition according to claim 1 or 3, characterized in that the collagen is obtained from Chondrosia reniformis.

5. The composition according to claim 1 or 2, characterized in that the additional component that is selected from among cationic, anionic or non-ionic deacetylated chitosans and chitosan derivatives and/or phenols from the group of halogenated dihydroxydiphenyl methanes, dihydroxydiphenyl sulfides and dihydroxydiphenyl ethers and/or substituted quaternary ammonium salts of alkylated phosphoric acid.

6. The composition according to claim 1, characterized in that the TiO₂-producing agent is selected from among:
0% to 100% by weight, preferably 1% to 99% by weight, of tetraethoxy orthotitanate,
0% to 100% by weight, preferably 1% to 99% by weight, of tetramethoxy orthotitanate,
0% to 100% by weight, preferably 1% to 99% by weight, of tetra-n-propoxy orthotitanate,
0% to 100% by weight, preferably 1% to 99% by weight, of tetra-i-propoxy orthotitanate, and
0% to 100% by weight, preferably 1% to 99% by weight, of tetra-t-butoxy orthotitanate,
0% to 100% by weight, preferably 1% to 99% by weight, of tetra-n-hexadecan-1-ol-oxyorthotitanate, and
0% to 100% by weight, preferably 1% to 99% by weight, of tetra-n-dodedecan-1-ol-oxyorthotitanate.

7. The composition according to claim 2, characterized in that the SiO₂-producing agent is selected from among:
0% to 100% by weight, preferably 1% to 99% by weight, of tetraethoxy silane,
0% to 100% by weight, preferably 1% to 99% by weight, of trimethoxymethyl silane, and
0% to 100% by weight, preferably 1% to 99% by weight, of dimethoxydimethyl silane.

8. The composition according to claim 5, characterized in that the halogenated dihydroxydiphenyl methane, dihydroxydiphenyl sulfide and dihydroxydiphenyl ether are selected from among 5,5′-dichloro-2,2′-dihydroxydiphenyl methane, 3,5,3′,5′-tetrachloro-4,4′-dihydroxydiphenyl methane, 3,5,6,3′,5′,6′-hexachloro-2,2′-dihydroxydiphenyl methane, 5,5′-dichloro-2,2′-dihydroxydiphenyl sulfide, 2,4,5,2′,4′,5′-hexachlorodihydroxydiphenyl sulfide, 3,5,3′,5′-tetrachloro-2,2′-dihydroxydiphenyl sulfide, 4,4′-dihydroxy-2,2′-dimethyl diphenyl methane, 2′,2-dihydroxy-5′,5-diphenyl ether or 2,4,4′-trichloro-2′-hydroxydiphenyl ether.

9. The composition according to claim 5 or 8, characterized in that the phenol is 2,4,4′-trichloro-2′-hydroxydiphenyl ether.

10. The composition according to claim 5, characterized in that it comprises cationic, anionic or non-ionic deacetylated chitosans and chitosan derivatives, preferably trimethyl chitosanium chloride, dimethyl-N-_{C2-C12}-alkyl chitosanium iodide, quaternary chitosan salts with anions of phosphoric acid, O-carboxymethyl chitin sodium salts, O-acyl chitosan, N,O-acyl chitosan, N-3-trimethyl ammonium-2-hydroxypropyl-chitosan and O-TEAE-chitin iodide.

11. The composition according to claim 5 or 10, characterized in that the chitosans and chitosan derivatives are low-molecular chitosans and chitosan derivatives, whereby the molecular weights are between 1.0×10⁵ g/mol and 3.5×10⁶ g/mol, preferably between 2.5×10⁵ g/mol and 9.5×10⁵ g/mol.

12. The composition according to claim 5, characterized in that it comprises quaternary ammonium salts of alkylated phosphoric acid, whereby each of the alkyl radicals, independently of each other, has 1 to 12 carbon atoms and/or halogenated ammonium salts, preferably cetyltrimethylammonium bromide, didecyldimethylammonium chloride, hexadecyl pyridinium chloride and polyoxyalkyl trialkyl ammonium chloride.

13. The composition according to one of claims 1 to 12, also containing conventional auxiliaries and additives, especially acidic and alkaline polycondensation catalysts and/or fluoride ions and/or complexing agents, especially β-diketones.

14. Nanoscale coating, especially with a thickness of 30 nm to 500 nm, preferably between 50 nm and 250 nm, containing an inorganic polymerized TiO₂ coating that is a applied onto a substrate material, whereby the coating contains 0.1% to 49% by weight, preferably 1% to 30% by weight, especially 2% to 20% by weight, relative to the total composition, of at least one additional component that is selected from among connective tissue protein, chitosans, phenols and/or substituted quaternary ammonium salts of alkylated phosphoric acid.

15. The coating according to claim 14, characterized in that up to 40 parts by weight, preferably 30 parts by weight, especially 20 parts by weight of the 100 parts by weight of the TiO₂ have been replaced by SiO₂ in the TiO₂ coating.

16. The coating according to claims 14 to 15 as a coating for hard surfaces, preferably for metal, ceramic and/or plastic or elastomer surfaces, especially those made of iron-based alloys or copper-based alloys.

17. The coating according to one of claims 14 to 16, characterized in that the substrate material contains a stainless steel, a chromium steel, a chromium-nickel steel, a chromium-nickel-molybdenum, a duplex stainless steel, a TRIP steel or a copper bronze or brass or red brass.

18. The coating according to claim 17, characterized in that the substrate material contains heavy metals with an antibacterial effect.

19. The coating according to claims 14 to 15, characterized in that the substrate material contains organic materials, especially wool, cotton (cellulose), textiles, paper, paperboard, natural sponge, synthetic sponge, leather, wood, cardboard and plastics.

20. The coating according to the preceding claims 14 to 15 in the form of packaging coating.

21. The coating according to the preceding claims 14 to 15, characterized in that the substrate material contains inorganic materials, especially metal, glass, carbon materials with and without epoxy resin impregnation, artificial stone such as concrete, bricks, tiles, facades, stucco and plaster, sintered ceramics and injection-molded ceramics such as SiC.

22. The coating according to claims 14 to 15, characterized in that the substrate material contains composite materials such as fiberglass-reinforced synthetic fabric and/or metal-synthetic fabric.

23. The coating according to the preceding claims 14 to 15, characterized in that the substrate material contains synthetic fibers, microfibers, felts and fabrics, especially those made of polyester, polypropylene, high-density polyethylene, low-density polyethylene, polyacrylonitrile, polyamide, polyimide, polyaramid, aramid, meta-aramid, para-aramid, polytetrafluorethylene, polyvinylidene fluoride, polyvinylidene chloride, polyphenylene sulfide, polyphenylene ether, polystyrene, polymethyl methacrylate, polymethacrylate, polybutylene terephthalate, polycarbonate, polycarbonate acrylonitrile butadiene styrene and their composites.

24. The coating according to the preceding claims 14 to 15, characterized in that the substrate material contains elastomeric compounds with fillers, especially EPDM, FKM, EPDM containing silicone, NBR, HNBR, FFKM, NR, SBR, CR, silicone, IIR, AU, CSM, EVM, EU, TPE-A, TPE-E, TPE-O, TPE-S, TPE-V, TPU.

25. A method for the production of a coating according to claims 14 to 15, characterized in that
in a first process step, a sol-gel with nanoscale particles is formed in a familiar manner by means of the hydrolysis of a precursor in water and,
in a second process step, the additional components according to claims 1 to 13, dissolved or dispersed in a hydrophilic solvent, are added to the sols and,
if applicable, temperature conditioning is carried out in a third process step.

26. A method for the production of a coating according to claims 14 to 15, characterized in that
in a first process step, a sol-gel with nanoscale particles is formed by admixing the precursor with a buffered organic solvent at room temperature in the absence of oxygen and,
in a second process step, the additional components according to claims 1 to 13, dissolved or dispersed in a hydrophobic solvent, are added to the sols and,
if applicable, temperature conditioning is carried out in a third process step.

27. The method according to claim 25, characterized in that the precursor is selected from among the group consisting of tetramethyoxy orthotitanate, tetraethoxy orthotitanate, tetrapropoxy orthotitanates, tetra-t-butoxy orthotitanate, tetra-n-hexadecan-1-ol-oxyorthotitanate and tetra-n-dodecan-1-ol-oxyorthotitanate, to which up to 40% by weight of tetra-methoxy orthosilicate or tetraethoxy orthosilicate, relative to the total content of TiO₂, have been added, and for the reaction to be carried out for 0.5 to 72 hours at temperatures ranging from 5° C. to 70° C. [41° F. to 158° F.].

28. The method according to claim 26, characterized in that the precursor is selected from among the group consisting of tetramethyoxy orthotitanate, tetraethoxy orthotitanate, tetrapropoxy orthotitanates, tetra-t-butoxy orthotitanate, tetra-n-hexadecan-1-ol-oxyorthotitanate and tetra-n-dodecan-1-ol-oxyorthotitanate, to which up to 40% by weight of tetramethoxy orthosilicate or tetraethoxy orthosilicate, relative to the total content of TiO₂, have been added, and that the reaction is carried out for 0.5 to 100 hours at temperatures ranging from 70° C. to 220° C. [158° F. to 428° F.] and at 0.5 bar to 5 bar excess pressure.

29. The method according to claim 25, characterized in that the hydrophilic solvent is selected from water and/or linear or branched alcohols having up to 6 carbon atoms, especially alcohols containing water, or water.

30. The method according to claim 26, characterized in that the hydrophobic solvent is high-boiling and stabilizing, especially it is octadecane, and/or it has a nanoscale physical-chemical interaction, especially it is benzyl alcohol or benzyl amine, and/or that the stabilization is carried out in a familiar manner by means of centrifugation, decanting and washing or in-situ or else postsynthetically by adding stabilizers, particularly fatty acids.

31. The method for the application of the coating composition obtained according to one of claims 1 to 13 onto substrate materials according to claims 15 to 24, which is done by contacting the surface at least once, especially by spraying, dipping, spinning, brushing, casting, padding, film-casting or using a spray bar with at least one spray nozzle.

32. Use of the coating composition according to claims 1 to 13 as an anti-fouling agent and biocide for surfaces that are in contact with aqueous and non-aqueous fluids.

33. The use of the coating composition according to claims 1 to 13 as an inner coating for containers, technical equipment, especially devices for pumping fluids, heat exchangers, evaporative coolers, boiler pipes, heating surfaces, spray absorbers, spray dryers, cooling aggregates, smokestacks made of metal, catalysts, turbines, fans, reactors, silos for food products, cement silos, lime silos, coal silos, membrane-type expansion tanks.

34. The use of the coating composition according to claims 1 to 13 as a flow-conducive coating with hydrolyzing properties.

35. The use of the coating composition according to claims 1 to 13 on or in packaging such as cardboard packaging on the basis of paper or paperboard as well as on the basis of textiles and woven or knit fabrics.

36. The use of the coating composition according to claims 1 to 13 as protection against glass corrosion of glass surfaces, especially windows, glass doors, structural elements and facade elements made of glass.

37. The use of the coating composition according to claims 1 to 13 as corrosion protection and wear-protection on metallic surfaces.

38. The use of the coating composition according to claims 1 to 13 as a protective coating on the inner of surface of refrigerators, freezers and cooling chambers, especially in commercial meat-cutting and meat-processing plants.

39. The use of the coating composition according to claims 1 to 13 as a protective coating for surfaces in commercial or private facilities, especially in hospitals, retirement homes, meat-processing plants, food-production facilities, industrial kitchens and in vehicles, especially in passenger cars, trucks, airplanes, buses, ships, trains and streetcars.

40. The use of the coating composition according to claims 1 to 13 as a protective coating for wallpaper, phones and keyboards.
